(19) United States
(12) Patent Application Publication
(10) Pub. No.: US 2026/0149217 A1
(43) Pub. Date: May 28, 2026

(54) CONNECTION BODY

(71) Applicant: JAPAN AVIATION ELECTRONICS INDUSTRY, LIMITED, Tokyo (JP)

(72) Inventor: Kenta ASHIBU, Tokyo (JP)

(73) Assignee: JAPAN AVIATION ELECTRONICS INDUSTRY, LIMITED, Tokyo (JP)

(21) Appl. No.: 19/365,784

(22) Filed: Oct. 22, 2025

(30) Foreign Application Priority Data
Nov. 27, 2024 (JP) 2024-206613

(51) Int. Cl. H01R 13/512; H01R 13/11; H01R 13/426

(52) U.S. Cl. CPC H01R 13/512; H01R 13/113; H01R 13/426

(57) ABSTRACT

A positional relationship between a nut portion and a first bolt insertion portion, included in a header, and a second bolt insertion portion and a third bolt insertion portion, included in a plug harness, is a relationship allows bolt-nut fastening by a bolt's insertion in a second state, in a first state with first terminals inserted into first hole portions from the first terminals' first contact surfaces, in which a pair of first pressing portions are allowed to press the first terminals, a pair of second terminals are inserted into second hole portions provided in pair, a first housing and a second housing are fitted together in a manner where each first hole portion faces an opening portion, a second holding member's second pressing portion is mounted on a predetermined region, and the pressing portions are allowed to be abutted on respective surfaces on the opposite side of the contact surfaces.

### TECHNICAL FIELD

The present disclosure relates to a connection structure of a connection body.

### BACKGROUND ART

As a conventional technology for connector assemblies, for example, Japanese Patent Application Laid Open No. 2024-4140 (hereinafter, referred to as "Patent Literature 1") discloses a connector assembly that reduces a manufacturing cost and size by simplifying the structure thereof. FIGS. 1 and 2 illustrate a structure of a connector assembly of a prior art. In the connector assembly of FIGS. 1 and 2, a connector assembly 10 includes a first connector 12 and a second connector 14. The first connector 12 includes: a first terminal metal fitting 16 protruded outward from a metal casing 20; and a metal hood portion 22 protruded from the casing 20 in a manner surrounding the first terminal metal fitting 16. The second connector 14 includes: a second terminal metal fitting 18 connected with the first terminal metal fitting 16; an insulative housing 74 that accommodates the second terminal metal fitting 18; and a metal flat plate portion 76 arranged fixedly on an outer surface side of the housing 74. In the connector assembly 10, in a state in which the first connector 12 and the second connector 14 are fitted to each other, the housing 74 of the second connector 14 is housed and arranged in the hood portion 22 of the first connector 12, and a contact portion 156 of the flat plate portion 76 is placed on and connected with a protruded end surface 64 of the hood portion 22, the flat plate portion 76 covering a protruded side opening portion 58 of the hood portion 22.

### SUMMARY OF THE INVENTION

In the connector assembly of Patent Literature 1, in the state in which the first connector 12 and the second connector 14 are fitted to each other, a fastening bolt 190 is inserted to fix the first connector 12 and the second connector 14 to each other (paragraph 0074). Further, in the connector assembly, conduction between the first connector 12 and the second connector 14 is achieved by making each first terminal metal fitting 16 and each second terminal metal fitting 18 electrically conductive (paragraph 0073). The second terminal metal fitting 18 is configured to include a second terminal metal fitting body 86 and a clip spring 88 serving as an elastic member attached to a tip portion (front end portion) of the second terminal metal fitting body 86 (paragraph 0040). That is, the connector assembly of Patent Literature 1 employs the configuration in which fitting is achieved by inserting the fastening bolt 190 and conduction is achieved with the clip spring 88, accordingly having problems in that the number of components increases and contact strength is insufficient, for example, as a connection structure for large currents.

An object of the present disclosure is to provide a connection body which suppresses increase in the number of components and enables connection that can withstand large currents.

To solve the above-described problems, a connection body according to the present embodiment includes: a header; and a plug harness which is fitted to the header. The header includes a first housing which is made of an insulating material, a pair of first terminals, a first holding member which is made of an insulating material, and a nut. The first housing has a pair of first hole portions formed in parallel with each other in a penetrating manner and a first bolt insertion portion formed between the pair of first hole portions in parallel with the pair of first hole portions. The first terminals have first contact surfaces on one ends thereof and have first contact portions having flat plate shapes to be able to be inserted into the respective first hole portions from a first contact surface side. The first holding member has a pair of first pressing portions for pressing each of the first terminals from a surface side opposite to the first contact surfaces to the first contact surface side in a first state in which the first terminals are inserted into the respective first hole portions from the first contact surfaces, a connecting portion for connecting the first pressing portions to each other, and a nut insertion portion formed in the connecting portion. The nut has a nut portion and a flange portion, the nut portion having a first end portion inserted into the nut insertion portion from a side opposite to a side on which the first pressing portions press and a second end portion opposite to the first end portion, the flange portion being made of metal and being fixed to the second end portion and engaging with a predetermined portion of the first housing so as to press the connecting portion from the side opposite to the side on which the first pressing portions press. The plug harness includes a second housing which is made of an insulating material and can be fitted to the first housing, a pair of second terminals, and a second holding member which is made of metal. The second housing has a pair of second hole portions formed in parallel with each other so that at least portions thereof face the first contact surfaces when the plug harness is fitted to the header, an opening portion formed so as to encompass a portion of each of the second hole portions and open in one direction of a first axis which intersects with a hole direction of the second hole portions, and a second bolt insertion portion formed between the pair of second hole portions in parallel with the first axis. The second terminals have second contact portions on one ends thereof, the second contact portions having flat plate shapes to be able to be inserted into the respective second hole portions. The second holding member has a second pressing portion used for pressing a predetermined region of a first surface in the one direction, the first surface being an outer surface of the second housing and having the second bolt insertion portion formed therein, and a third bolt insertion portion penetrating through the second pressing portion. A positional relationship between the nut portion, the first bolt insertion portion, the second bolt insertion portion, and the third bolt insertion portion is a positional relationship which allows fastening of the bolt and the nut by insertion of a single bolt in a second state in which the pair of first pressing portions are allowed to press the respective first terminals, the pair of second terminals are inserted into the respective second hole portions provided in pair, the first housing and the second housing are fitted to each other in a manner in which each of the first hole portions and the opening portion face each other, the second pressing portion of the second holding member is mounted on the predetermined region, and the first pressing portions of the first holding member are allowed to be abutted on respective surfaces, the surfaces being on an opposite side to the first contact surfaces of the first terminals, in the first state. The fastening between the bolt and the nut makes the first contact portions and the respective second contact portions conductive.

### EFFECTS OF THE INVENTION

According to the connection body of the present embodiment, increase in the number of components can be suppressed and connection that can withstand large currents can be achieved.

### BRIEF DESCRIPTION OF THE DRAWINGS

FIG. 1 illustrates a connector assembly of a prior art.

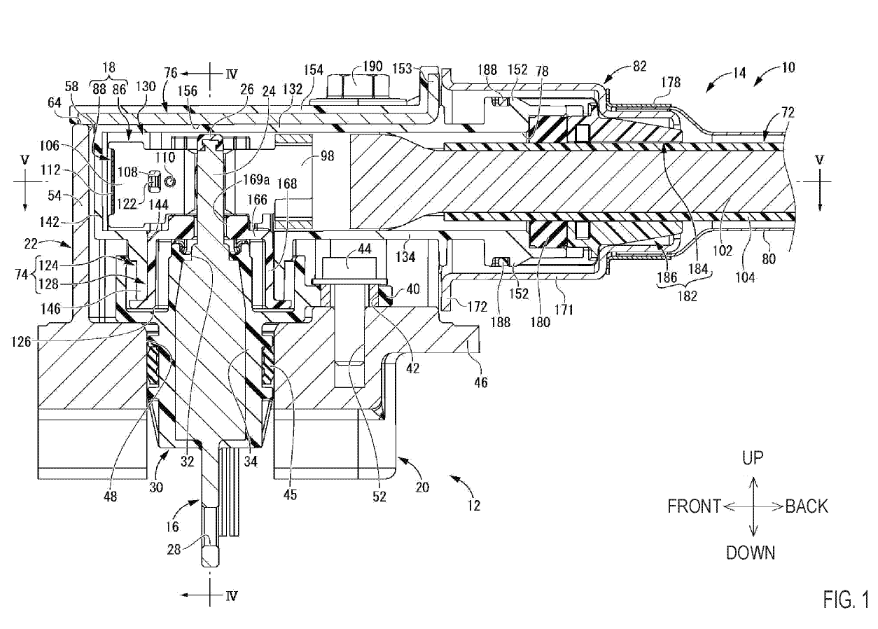

FIG. 2 illustrates the connector assembly of the prior art.

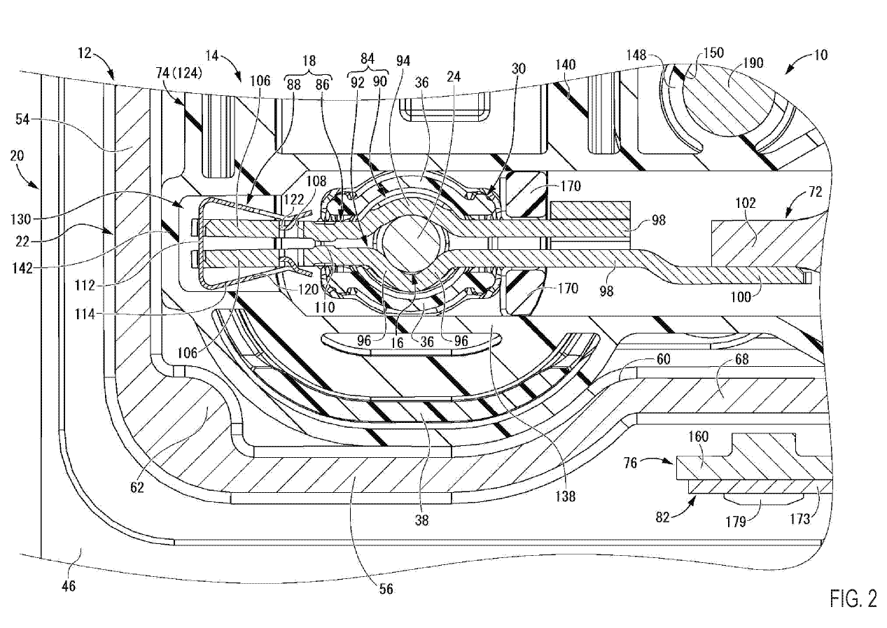

FIG. 3 illustrates an example of a connection body according to a first embodiment, where A is a perspective view, B is a plan view, and C is a left side view.

FIG. 4 is an exploded perspective view of a connection body 1A.

FIG. 5 is a sectional view taken along a K-K line in B of FIG. 3.

FIG. 6 is a sectional view taken along an L-L line in B of FIG. 3.

FIG. 7 is a sectional view taken along an I-I line in C of FIG. 3.

FIG. 8 illustrates a header 2A, where A is a perspective view, B is a plan view, and C is a left side view.

FIG. 9 is a sectional view taken along an F-F line in C of FIG. 8.

FIG. 10 illustrates a first housing 10A, where A is a plan view, B is a sectional view taken along a Q-Q line in A, C is a sectional view taken along an R-R line in A, and D is a sectional view taken along a P-P line in A.

FIG. 11 is a perspective view illustrating a nut 40A.

FIG. 12 illustrates a plug harness 3A, where A is a plan view, B is a sectional view taken along a D-D line in A, and C is a bottom surface view.

FIG. 13 illustrates a second housing 50A, where A is a plan view, B is a sectional view taken along an N-N line in A, C is a sectional view taken along an O-O line in A, and D is a sectional view taken along an M-M line in A.

FIG. 14 is a perspective view illustrating a slide cover 55A.

FIG. 15 is an enlarged view of the slide cover 55A and its surroundings in a sectional view taken along an S-S line in C of FIG. 3 .

### DETAILED DESCRIPTION OF THE EMBODIMENTS

### First Embodiment

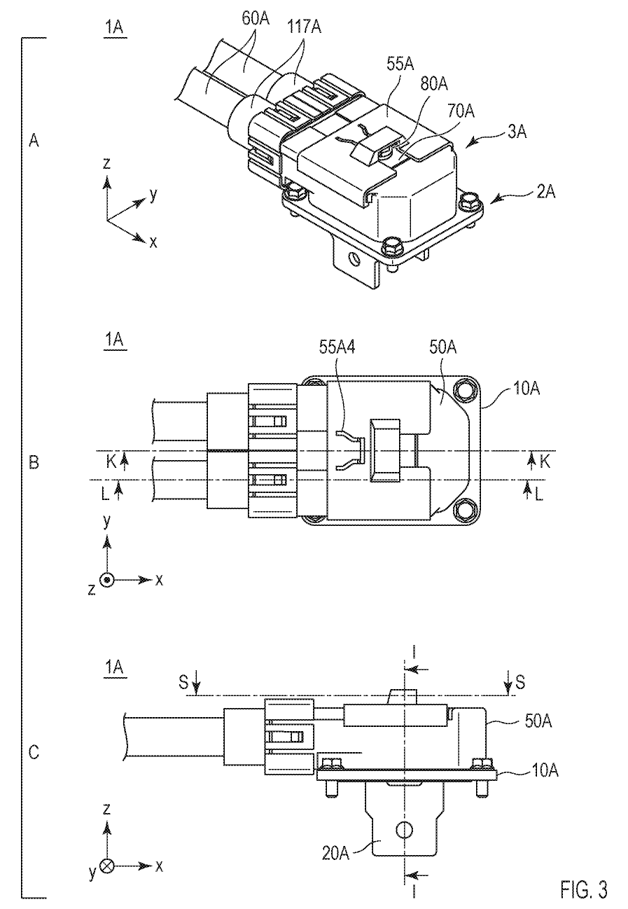

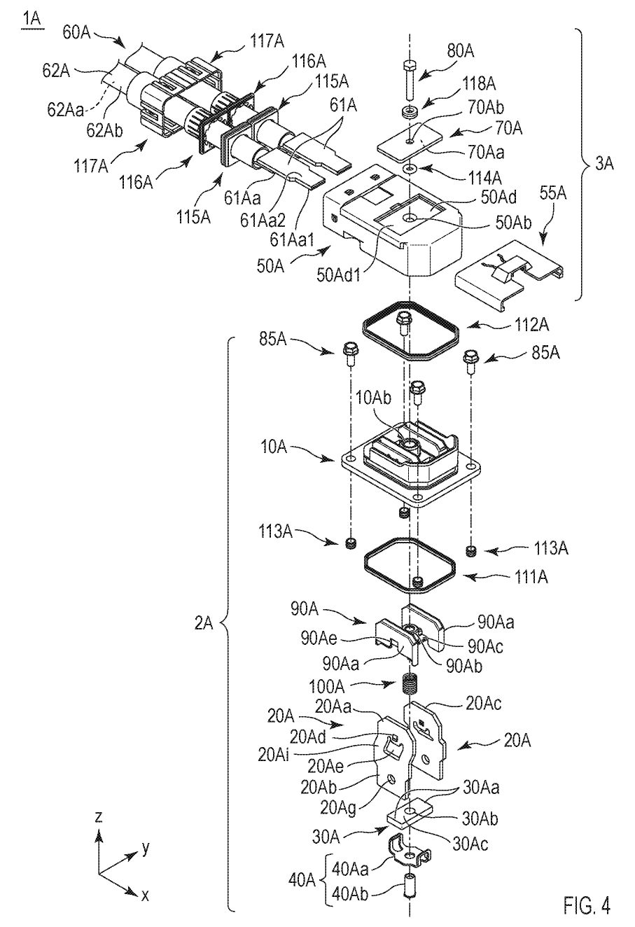

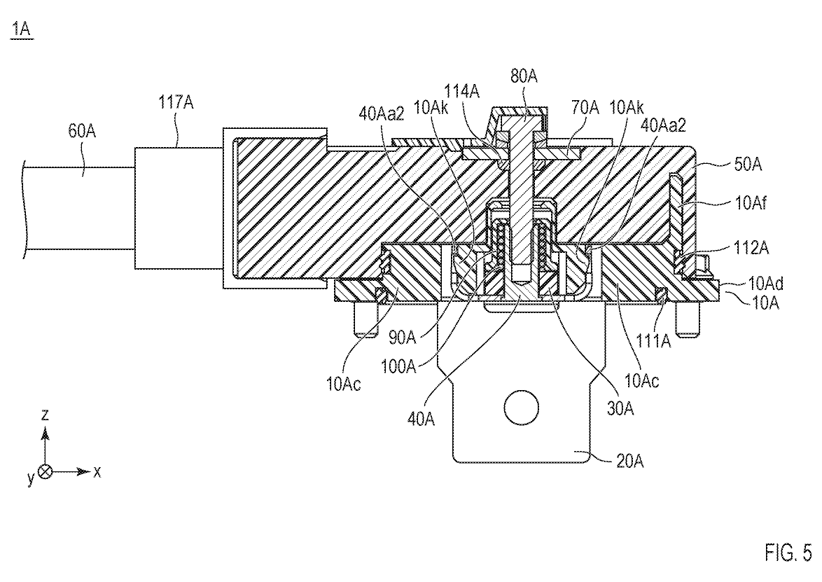

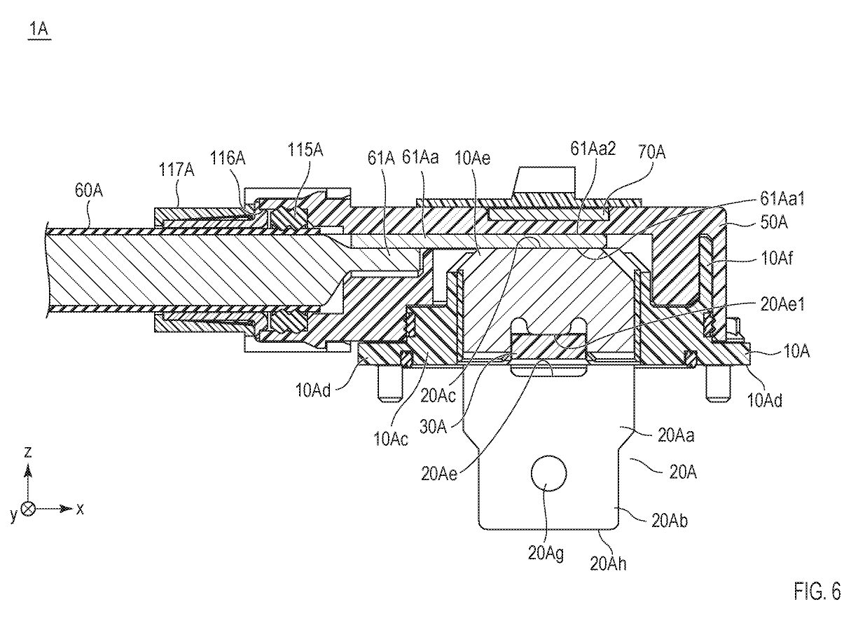

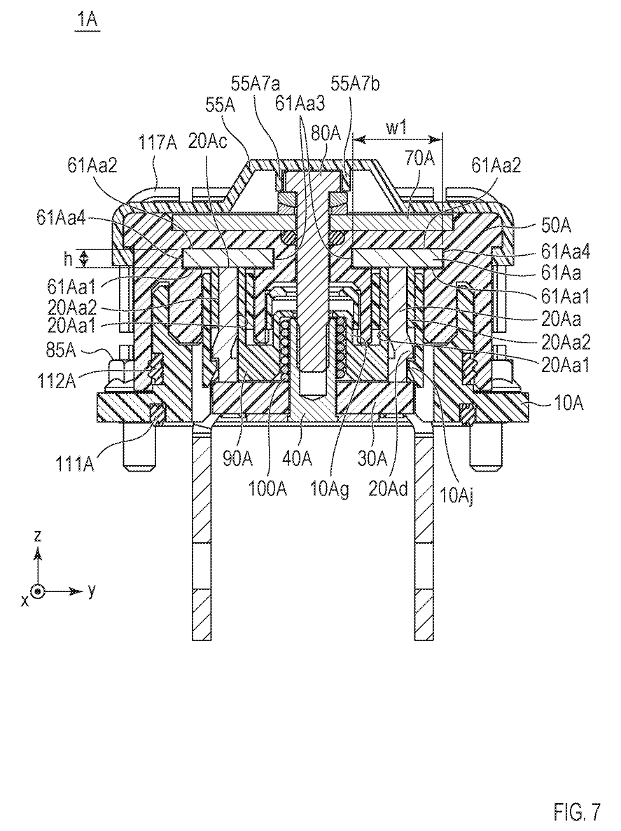

A connection body according to a first embodiment of the present disclosure will be described below with reference to the accompanying drawings. Here, components having the mutually-same functions will be provided with the mutually-same reference characters and the duplicate description thereof will be omitted. FIG. 3 illustrates an example of the connection body according to the first embodiment, where A is a perspective view, B is a plan view, and C is a left side view. FIG. 4 is an exploded perspective view of a connection body 1A. FIG. 5 is a sectional view taken along a K-K line in B of FIG. 3. FIG. 6 is a sectional view taken along an L-L line in B of FIG. 3. FIG. 7 is a sectional view taken along an I-I line in C of FIG. 3.

A connection body of the present disclosure is, for example, a connector for large currents of several hundred amperes. However, the connection body of the present disclosure does not limit the magnitude of the current, and does not preclude application thereof at larger or smaller currents. The connection body 1A according to the present embodiment is composed of a header 2A and a plug harness 3A which is fitted to the header 2A, as illustrated in FIGS. 3 and 4.

### Header 2A

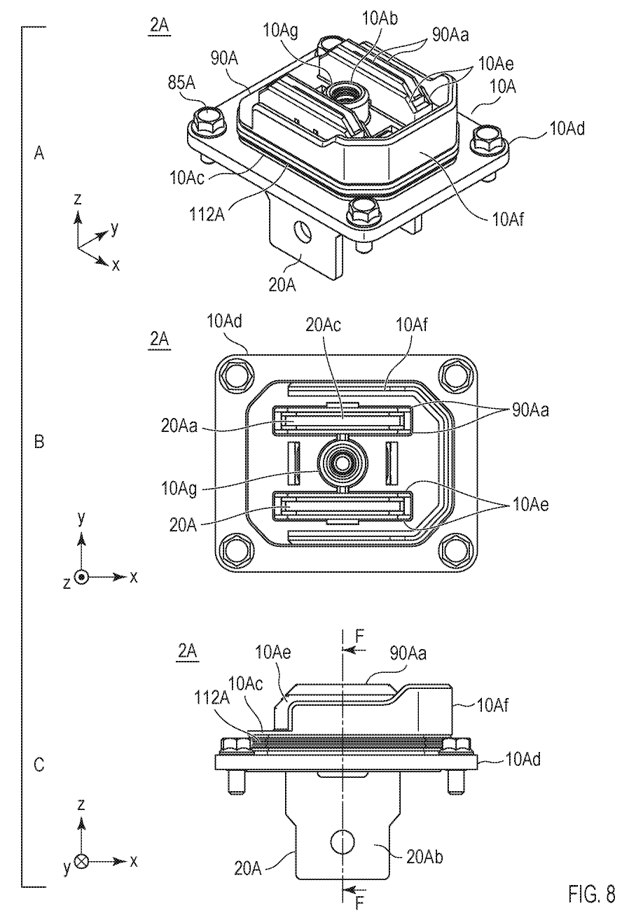

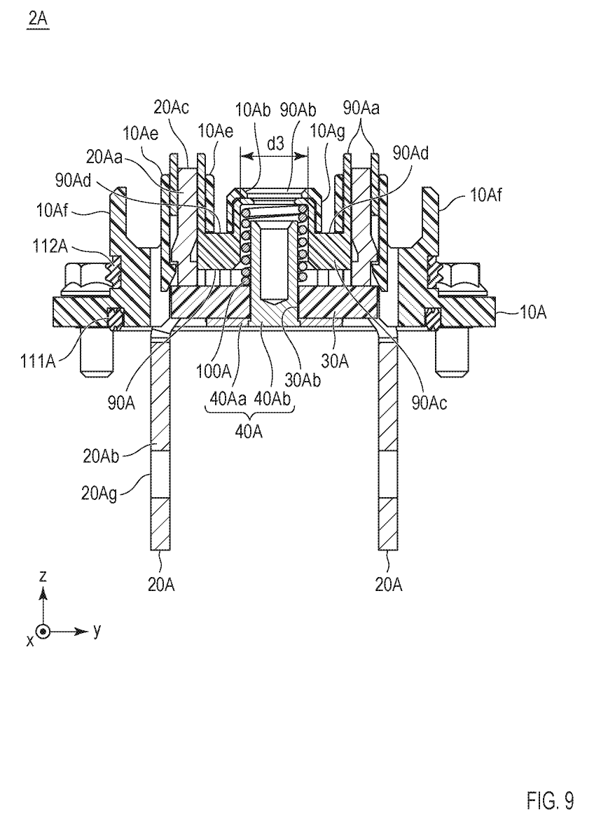

FIG. 8 illustrates the header 2A, where A is a perspective view, B is a plan view, and C is a left side view. FIG. 9 is a sectional view taken along an F-F line in C of FIG. 8. As illustrated in FIGS. 4 and 8, the header 2A includes a first housing 10A, a pair of first terminals 20A, a first holding member 30A, a shutter member 90A, an elastic member 100A, a first seal member 111A, a second seal member 112A, and a nut 40A. The header 2A of the present embodiment includes four sets of bolts 85A and collars 113A for joining with other components, such as a circuit board, or products (not shown). However, the header 2A does not have to include the bolts 85A or the collars 113A.

### Housing 10A

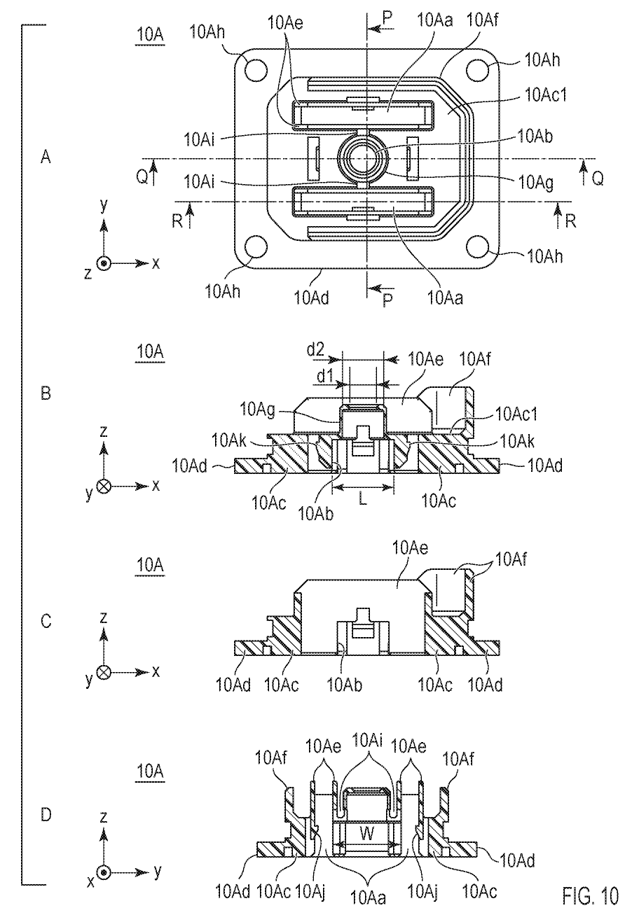

FIG. 10 illustrates the first housing 10A, where A is a plan view, B is a sectional view taken along a Q-Q line in A, C is a sectional view taken along an R-R line in A, and D is a sectional view taken along a P-P line in A.

As illustrated in FIG. 9, the first housing 10A accommodates the first terminals 20A, the first holding member 30A, the shutter member 90A, the elastic member 100A, and the nut 40A, and positions at least part of each of these components. When the first holding member 30A is inserted in the first housing 10A, convex portions 20Ad and convex portions 10Aj are fitted to each other, as illustrated in FIG. 7. Accordingly, the pair of first terminals 20A, the shutter member 90A, the elastic member 100A, and the first holding member 30A are held in the first housing 10A. The first housing 10A is made of, for example, an insulating material such as resin. In this example, the first housing 10A has a base 10Ac and a flange portion 10Ad. The base 10Ac is based on a substantially octagonal rectangular cross section, and the flange portion 10Ad extends from the lower end side of the base 10Ac (the end portion side in the -z direction in FIG. 10) in an outward direction in a manner to expand the cross sectional area of the octagonal rectangle so as to form a rounded rectangular outer shape, as illustrated in FIG. 10.

The base 10Ac has a peripheral wall 10Af, which is formed so that peripheral wall 10Af opens a portion of an edge portion on the rear side (the -x direction side in FIG. 10) of an upper surface 10Ac1 and encloses the rest of the edge portion in a raised manner. The base 10Ac has a pair of first hole portions 10Aa and a first bolt insertion portion 10Ab. The first hole portions 10Aa have rectangular hole shapes which are formed in parallel with each other in a penetrating manner in a vertical direction (the z-axis direction in FIG. 10) in a region surrounded by the peripheral wall 10Af. The first bolt insertion portion 10Ab is formed between the pair of first hole portions 10Aa in parallel with the pair of first hole portions 10Aa so as to allow a bolt 80A to be inserted therethrough. The upper surface 10Ac1 has a shutter cover 10Ae around the edge portion of each of the first hole portions 10Aa. The shutter cover 10Ae is formed to be raised upward (the +z direction in FIG. 10) from the first hole portion 10Aa. The shutter cover 10Ae has a shape covering the periphery on the tip end side of a first contact portion 20Aa (FIG. 9). On the upper surface 10Ac1, a boss 10Ag is formed around the end portion of the first bolt insertion portion 10Ab to be extended upward (the +z direction of FIG. 10) from the first bolt insertion portion 10Ab. The size of the hole in the first bolt insertion portion 10Ab, including the size of the hole in the boss 10Ag, has a diameter d1 which is slightly larger than the diameter of the bolt 80A at the entrance of the hole of the boss 10Ag. The first bolt insertion portion 10Ab has a diameter d2 which is slightly larger than the diameter of the elastic member 100A in the direction entering inside (the -z direction in FIG. 10), and further inside, the first bolt insertion portion 10Ab has a rectangular cross-sectional hole shape with width W (D of FIG. 10) and length L (B of FIG. 10) which is connected to the first hole portion 10Aa. On the outside of the hole shape, a pair of convex portions 10Ak with which respective lock arm portions 40Aa2 of the nut 40A are engaged are formed. The upper surface 10Ac1 has a pair of hole portions 10Ai which are formed between each shutter cover 10Ae and the boss 10Ag so that a rib 90Ad of the shutter member 90A can be inserted therethrough.

As illustrated in A of FIG. 10, the flange portion 10Ad has hole portions 10Ah which are formed near four rounded corners and into which the respective collars 113A (FIG. 4) can be inserted by caulking. The collar 113A is made of, for example, metal such as stainless steel, and the bolt 85A can be inserted into each of the hole portions 10Ah to which the collars 113A are attached (FIG. 8).

### First terminal 20A

The first terminal 20A is a conductive flat plate which has the first contact portion 20Aa and an extended portion 20Ab, which is connected to the first contact portion 20Aa, as illustrated in FIGS. 4 and 6. The first terminal 20A is made of copper, in this example.

The first contact portion 20Aa is a flat plate having an octagonal shape obtained by removing the corners of a vertically-long substantially-rectangular shape, and has a first contact surface 20Ac at the end portion on the upper side (the second contact portion 61Aa side, the +z direction side in FIG. 6), in the view of FIG. 6. The first contact portions 20Aa have flat plate shapes to be able to be inserted into the respective first hole portions 10Aa (FIG. 10) from the first contact surface 20Ac side. Here, the first contact portion 20Aa is divided into three substantially equal regions, that is, an upper portion, a middle portion, and a lower portion, from top to bottom in the view of FIG. 6, and the region corresponding to the middle portion is referred to as a connecting portion 20Ai. The upper portion and the lower portion of the first contact portion 20Aa are formed to be extended along the z-axis direction in FIG. 4 (that is, the insertion direction of a nut insertion portion 30Ab, the first bolt insertion portion 10Ab, and a fourth bolt insertion portion 90Ab). The connecting portion 20Ai in this example is configured to connect the upper portion and the lower portion so that the lower portion is shifted outward relative to the upper portion.

Each of the first contact portions 20Aa has a hole portion 20Ae which has a substantially horizontally elongated rectangular shape and into which a first pressing portion 30Aa of the first holding member 30A is inserted, on a center portion of the connecting portion 20Ai. The hole portion 20Ae is cut out so that its hole shape expands toward the first contact surface 20Ac at both end portions in the longitudinal direction of the hole. When the first pressing portion 30Aa is inserted into the hole portions 20Ae, the first contact portion 20Aa is in an upright position with respect to the first holding member 30A. Each of the first contact portions 20Aa has the convex portion 20Ad (FIG. 4), on the slightly upper end side (the second contact portion 61Aa side, the +z direction side in FIG. 6) relative to the center portion of the surface that faces the outside when the connection body 1A is assembled. The convex portion 20Ad has a substantially trapezoidal cross-sectional shape which gradually changes so that the plate thickness of the first terminal 20A in the portion, in which the convex portion 20Ad is formed, increases toward the lower side (the -z direction in FIG. 4). In this example, the convex portion 20Ad is formed by dowel processing, and a concave portion is formed on a surface opposite to the surface, on which the convex portion 20Ad is formed, at a position opposed to the convex portion 20Ad. The first terminals 20A thus have the convex portions 20Ad, whereby the first terminals 20A engage with the convex portions 10Aj (D of FIG. 10), which are formed in the first hole portions 10Aa of the first housing 10A, so as to be held in the first housing 10A (see FIG. 7).

The extended portion 20Ab extends from the lower end (the end portion on the -z direction side in FIG. 6) of the first contact portion 20Aa in a downward direction (the direction away from the second contact portion 61Aa, the -z direction in FIG. 6) in a manner to maintain the width of the lower end. The extended portion 20Ab has a hole portion 20Ag which can be used for coupling with other components or products (not shown) on the slightly upper end side (the first contact portion 20Aa side, the +z direction side in FIG. 6) relative to the center portion thereof, in this example.

### First holding member 30A

The first holding member 30A is a plate which has a thin rectangular parallelepiped shape and is made of an insulating material. The first holding member 30A is made of glass epoxy resin in this example. However, as long as the insulation property is ensured, the first holding member 30A may be made of a separator structure of glass epoxy resin and stainless steel, for example. As illustrated in FIG. 4, the first holding member 30A has a pair of first pressing portions 30Aa which are regions on both end portion sides in the longitudinal direction (the y-axis direction in FIG. 4), and a connecting portion 30Ac which connects the pair of first pressing portions 30Aa. The connecting portion 30Ac has the nut insertion portion 30Ab, through which a nut portion 40Ab of the nut 40A can be inserted, on the center portion thereof. The first holding member 30A presses each of the first terminals 20A from the surface (surface 20Ae1 in FIG. 6) side opposite to the first contact surface 20Ac to the first contact surface 20Ac side in a first state in which the first terminals 20A are inserted into the respective first hole portions 10Aa (FIG. 10) from the first contact surface 20Ac. The nut insertion portion 30Ab, into which the nut portion 40Ab is inserted, is configured so that the nut insertion portion 30Ab faces the fourth bolt insertion portion 90Ab when the header 2A is assembled.

Here, the first holding member 30A may have other configurations as long as the first holding member 30A can press the first terminals 20A from the surface side opposite to the first contact surface 20Ac to the first contact surface 20Ac side. In this configuration, other components are to be adjusted in shape appropriately, for example, so that the nut 40A still can press the first holding member 30A.

### Shutter member 90A

The shutter member 90A is an insulating member including a pair of shutter portions 90Aa, a connecting portion 90Ac, which connects the pair of shutter portions 90Aa, and the fourth bolt insertion portion 90Ab, which is formed in a center portion of the connecting portion 90Ac and has a boss shape and through which the bolt 80A can be inserted, as illustrated in FIG. 4. The shutter member 90A is made of resin in this example.

The shutter portion 90Aa has a hollow box-like shape which opens in the vertical direction (the z-axis direction in FIG. 4) to allow insertion and movement of the first terminal 20A. The shutter portion 90Aa has a shape covering the periphery on the tip end side of the first contact portion 20Aa. In other words, the pair of shutter portions 90Aa cover respective peripheries of one end portions of the pair of first contact portions 20Aa with the end portions thereof exposed.

The shutter member 90A has a pair of ribs 90Ad on the connecting portion 90Ac so as to further strongly support the shutter portions 90Aa and the fourth bolt insertion portion 90Ab, as illustrated in FIG. 9.

As the shape of the hole inside the fourth bolt insertion portion 90Ab, the entrance has a diameter slightly larger than the bolt 80A, and the inside is formed in a shape of a hole with a diameter d3 which is slightly larger than the elastic member 100A so that the elastic member 100A can be inserted.

### Elastic member 100A

The elastic member 100A of the present embodiment has a coil spring shape as illustrated in FIG. 9. The elastic member 100A is made of stainless steel in this example. The elastic member 100A has an inner diameter which is slightly larger than the diameter of the bolt 80A so that the bolt 80A can be inserted therethrough. One end of the elastic member 100A is mounted on the nut insertion portion 30Ab of the first holding member 30A. The other end is inserted into the inside of the fourth bolt insertion portion 90Ab. Accordingly, at least a portion of the elastic member 100A is positioned between the first holding member 30A and the connecting portion 90Ac when the header 2A is assembled. Further, the elastic member 100A is positioned in the fourth bolt insertion portion 90Ab when the connection body 1A is assembled.

The provision of the elastic member 100A produces the following positional relationship between the shutter portion 90Aa and the first contact portion 20Aa in the header 2A before the header 2A and the plug harness 3A are fitted to each other. As illustrated in FIG. 8, the end portion on the upper side (the +z direction side in FIG. 8) of the first contact portion 20Aa is positioned in the inside of the opening portion formed by the shutter portion 90Aa. That is, the tip end of the shutter portion 90Aa is positioned on the upper side (the +z direction side in FIG. 8) compared to the tip end of the first contact surface 20Ac. This configuration ensures safety by preventing a human finger or the like from directly touching the first terminal 20A from the shutter portion 90Aa side. Even if a person were to press down the shutter portion 90Aa, the elastic member 100A is compressed to exert a spring reaction force, making it difficult to press down the shutter portion 90Aa more than a predetermined amount with the force of a finger press down. Meanwhile, by fastening the header 2A and the plug harness 3A using the nut 40A and the bolt 80A, the first terminal 20A moves upward (in the +z direction in FIG. 7) with respect to the shutter member 90A to a position where the first contact surface 20Ac is flush with the tip end of the shutter portion 90Aa. In other words, the elastic member 100A causes the shutter member 90A to move from a position where the end portion (the first contact surface 20Ac) of the first contact portion 20Aa is within the opening portion formed by the shutter member 90A (FIGS. 8 and 9) to a position where the end portion of the first contact portion 20Aa and the end portion of the tip of the shutter member 90A are flush with each other (FIG. 7) from before the completion of fastening of the header 2A with the plug harness 3A by the bolt 80A and the nut 40A to the completion. To put it further, before fastening is completed, the shutter member 90A is pressed by the elastic member 100A, and the end portion of the shutter portion 90Aa is accordingly positioned on the pressing direction side of the first pressing portion 30Aa (the +z direction side in FIG. 8) relative to the end portion (the first contact surface 20Ac) of the first contact portion 20Aa. From before the completion of fastening to the completion, the shutter member 90A moves to a position where the end portion (the first contact surface 20Ac) of the first contact portion 20Aa is allowed to be conduct with the second contact portion 61Aa (the -z direction side in FIG. 8). Accordingly, the first contact surface 20Ac is joined with the second contact portion 61Aa. The shutter member 90A has a concave portion 90Ae (FIG. 4), which allows the shutter member 90A to move downward (the -z direction side in FIG. 8) with respect to the first terminal 20A without interfering with the convex portion 10Aj.

### Nut 40A

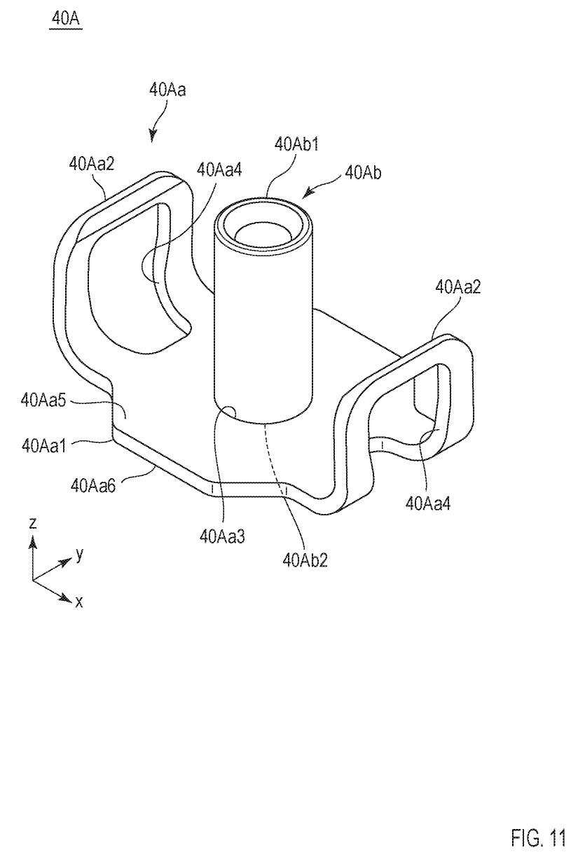

FIG. 11 is a perspective view illustrating the nut 40A. The nut 40A has a flange portion 40Aa and the nut portion 40Ab, as illustrated in FIGS. 4 and 11. The nut 40A is a flange nut or a nut having the function of a flange nut.

The flange portion 40Aa has a flange main body portion 40Aa1 and a pair of lock arm portions 40Aa2. The flange main body portion 40Aa1 is a thin metal flat plate having a substantially octagonal shape and including an upper surface 40Aa5 and a lower surface 40Aa6 which is an opposite surface to the upper surface 40Aa5. The flange main body portion 40Aa1 has the size enough to cover the connecting portion 30Ac in this example. The flange portion 40Aa has a hole portion 40Aa3, in which a second end portion 40Ab2 of the nut portion 40Ab can be pressed and inserted, at the center portion of the flange main body portion 40Aa1. The flange portion 40Aa has the pair of lock arm portions 40Aa2 at respective end portions of the flange main body portion 40Aa1, which correspond to positions in a front and rear direction when the connection body 1A is assembled. Each of the lock arm portions 40Aa2 extends slightly outward in a horizontal direction (the x-axis direction) from two positions, which are separated by a predetermined width, in a manner to connect with the flange main body portion 40Aa1, and changes the extension direction from tip ends of the extension points upward (the +z direction) and further extends, and the two extended portions are coupled to each other at the extension point in an facing manner, forming an opening portion 40Aa4. In other words, each of the lock arm portions 40Aa2 connects with the flange main body portion 40Aa1 and has an annular shape with the opening portion 40Aa4. The nut 40A is incorporated in the first housing 10A. Specifically, the nut portion 40Ab is inserted into the nut insertion portion 30Ab from below the first holding member 30A. This insertion is continued up to the position where the lock arm portions 40Aa2 engage with the convex portions 10Ak. The nut 40A is thus incorporated in the first housing 10A. When the connection body 1A is assembled, the flange portion 40Aa is exposed from the header 2A at least at a portion of the lower surface 40Aa6 which is opposite to the surface (the upper surface 40Aa5) which presses the connecting portion 30Ac.

The nut portion 40Ab has a cylindrical shape in this example, and includes a first end portion 40Ab1, which is one end portion of the cylindrical shape, and the second end portion 40Ab2, which is the other end portion of the cylindrical shape and is an opposite end portion to the first end portion 40Ab1. The first end portion 40Ab1 is inserted into the nut insertion portion 30Ab from the side opposite to the one on which the first pressing portion 30Aa presses. The nut portion 40Ab is a so-called spacer nut or a nut having the function of a spacer nut. The nut portion 40Ab has a screw portion. Specifically, the nut portion 40Ab has a screw portion, which can be fastened with a screw portion of the bolt 80A, in the cylindrical shape from the first end portion 40Ab1 toward the second end portion 40Ab2. By pressing and inserting the second end portion 40Ab2 of the nut portion 40Ab in this example into the hole portion 40Aa3, the flange portion 40Aa and the nut portion 40Ab are integrated.

### Plug harness 3A

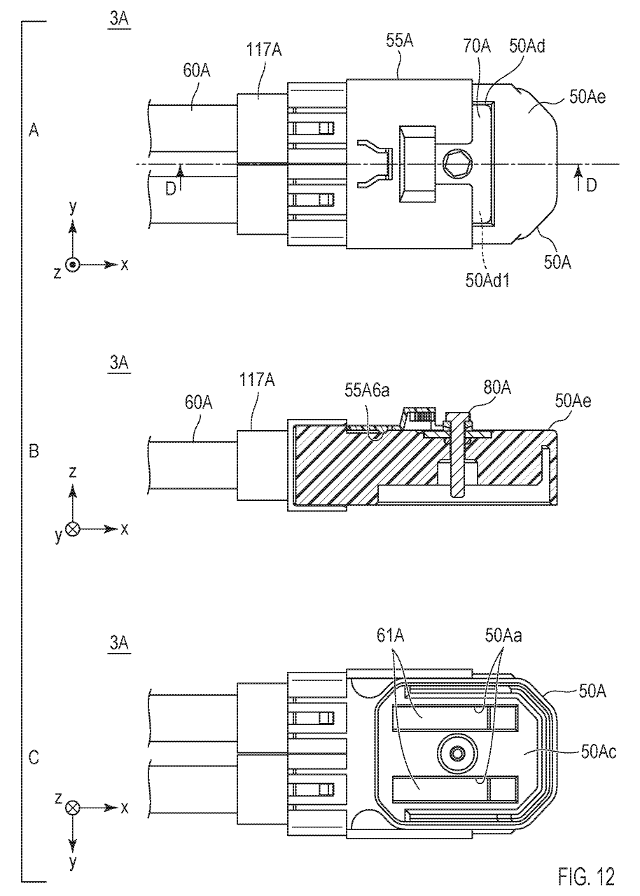

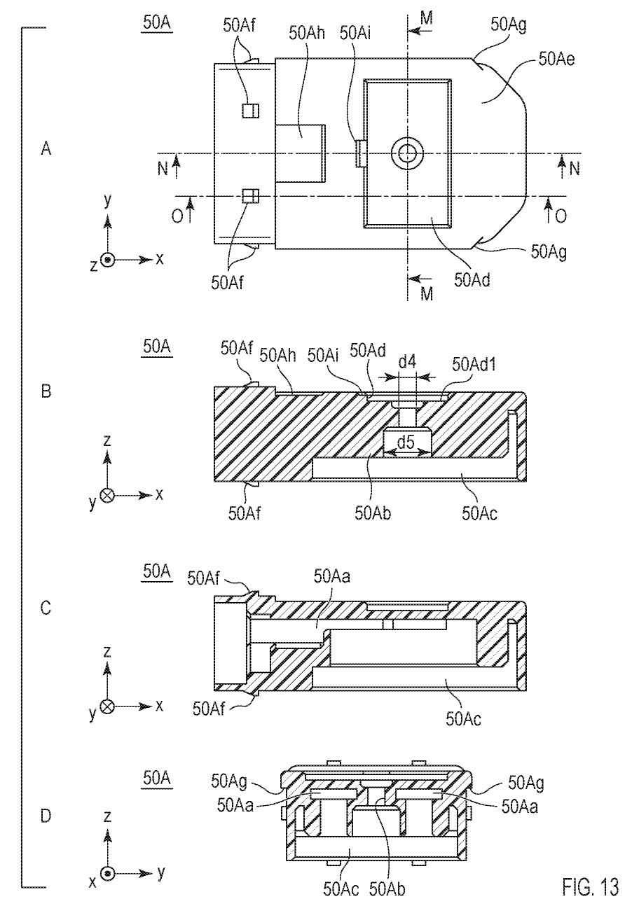

FIG. 12 illustrates the plug harness 3A, where A is a plan view, B is a sectional view taken along a D-D line in A, and C is a bottom surface view. FIG. 13 illustrates a second housing 50A, where A is a plan view, B is a sectional view taken along an N-N line in A, C is a sectional view taken along an O-O line in A, and D is a sectional view taken along an M-M line in A.

As illustrated in FIGS. 4 and 12, the plug harness 3A includes the second housing 50A, a harness 60A, a second holding member 70A, a seal member 114A, a spherical washer 118A, the bolt 80A, and a slide cover 55A. The plug harness 3A of the present embodiment includes seal members 115A, cable retainers 116A, and covers 117A around the harness 60A, as illustrated in FIG. 4. In the present embodiment, even a plug harness which does not include the spherical washer 118A, the bolt 80A, the slide cover 55A, the seal members 115A, the cable retainers 116A, or the covers 117A may also be referred to as the plug harness 3A.

### Second housing 50A

The second housing 50A has a substantially rectangular parallelepiped shape with one end tapered as illustrated in FIG. 13, and is made of, for example, an insulating material such as resin. The second housing 50A positions second terminals 61A and the second holding member 70A.

The second housing 50A has a pair of second hole portions 50Aa, an opening portion 50Ac, and a second bolt insertion portion 50Ab through which the bolt 80A can be inserted.

The pair of second hole portions 50Aa in this example are formed parallel to (in parallel with) the longitudinal direction (the x-axis direction in FIG. 13) of the second housing 50A so that the rear side (the -x direction side in FIG. 13) is open and the front side (the +x direction side in FIG. 13) is closed. The second hole portions 50Aa are formed in parallel so that at least portions thereof face the first contact surfaces 20Ac when the plug harness 3A is fitted to the header 2A. The second hole portion 50Aa has a hole shape whose tip end side is slightly larger than the shape of the second terminal 61A so that the second terminal 61A side of the harness 60A can be inserted therein, as illustrated in C of FIG. 13. The center portion of the hole in the extension direction has a hole shape slightly larger than the outer shape of a cable 62A. The end portion near the entrance of the hole (the end portion on the -x direction side in FIG. 13) is formed into a rectangular hole shape so that the seal member 115A (FIG. 4) serving as a waterproof member can be inserted.

The opening portion 50Ac is formed so as to encompass a portion of each of the second hole portions 50Aa and open in one direction (the -z direction in FIG. 13) of a first axis (an axis parallel to the z axis in FIG. 13) that intersects with the hole direction of the second hole portion 50Aa. Accordingly, the cross-sectional shape of the opening portion 50Ac is such that an O-O cross section of A of FIG. 13, which encompasses a portion of the second hole portion 50Aa, has the shape illustrated in C of FIG. 13, while in a portion without the second hole portion 50Aa, for example, an N-N cross section of A of FIG. 13 has the shape illustrated in B of FIG. 13. Thus, the opening portion 50Ac is formed so that the base 10Ac, peripheral wall 10Af, shutter covers 10Ae, and boss 10Ag of the first housing 10A are accommodated within the second housing 50A, as shown in FIGS. 5 to 7. That is, the second housing 50A is formed to be able to be fitted to the first housing 10A.

The second bolt insertion portion 50Ab is formed between the pair of second hole portions 50Aa in parallel with the above-mentioned first axis (the z axis in FIG. 13) so as to penetrate through the second housing 50A, as illustrated in FIG. 13. The second bolt insertion portion 50Ab is formed on a position facing the first bolt insertion portion 10Ab when the second housing 50A is fitted to the first housing 10A. The size of the hole of the second bolt insertion portion 50Ab has a diameter d4 which is slightly larger than that of the bolt 80A near a surface 50Ad1 described below. In the direction entering the inside, the second bolt insertion portion 50Ab has a diameter d5 slightly larger than the boss 10Ag, and further inward, the second bolt insertion portion 50Ab expands into a hole that can accommodate the base 10Ac.

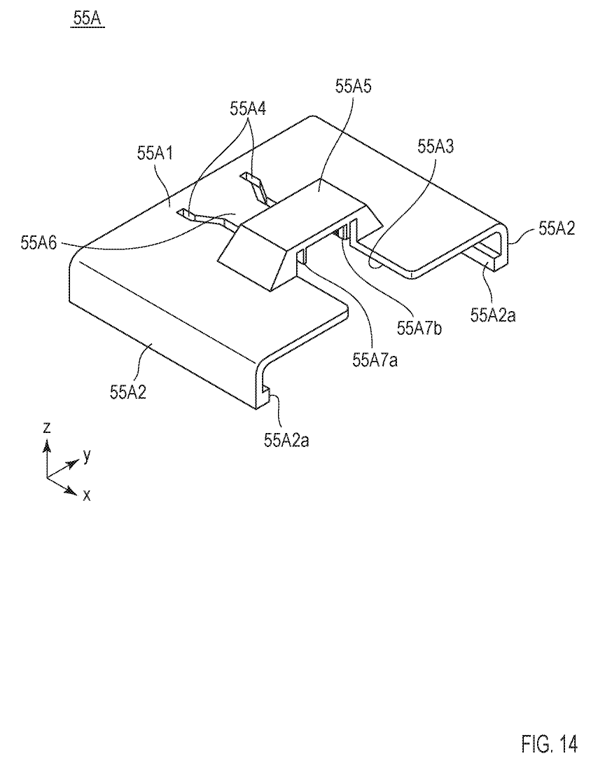

The second housing 50A has the surface 50Ad1 in a region from near the center of the second housing 50A to the front side (the +x direction side in FIG. 13) in an upper surface 50Ae of the second housing 50A. The surface 50Ad1 in this example is formed as a surface of a groove portion 50Ad which is slightly lower than the upper surface 50Ae. The surface 50Ad1 forms a predetermined region on which the second holding member 70A is to be mounted. The groove portion 50Ad is not an essential structure in the present disclosure, and it is sufficient that the upper surface 50Ae has the region on which the second holding member 70A is mounted (a region corresponding to the surface 50Ad1). Therefore, the upper surface 50Ae including the surface 50Ad1 may be simply referred to as the "upper surface 50Ae" or "first surface". Here, around the end portion on the rear side of the second housing 50A, a plurality of convex portions 50Af for fitting the cover 117A to the second housing 50A are formed. Further, at respective end portions in the width direction (the y-axis direction) of the second housing 50A, guide portions 50Ag protruding outward are provided from the front side to the rear side. The guide portions 50Ag engage with respective engagement portions 55A2a (see FIG. 14) of the slide cover 55A to guide the movement of the slide cover 55A on the second housing 50A. The upper surface 50Ae has a first concave portion 50Ah and a second concave portion 50Ai, which are groove portions for engaging with a convex portion 55A6a (see FIG. 12) of the slide cover 55A. The first concave portion 50Ah and the second concave portion 50Ai are both formed on the center portion in the width direction (the y-axis direction) of the second housing 50A. The first concave portion 50Ah is formed along the end portion of the upper surface 50Ae on the rear side, and in this example, has a width which is substantially twice as large as the width of the convex portion 55A6a. The second concave portion 50Ai is formed to have a width which is slightly larger than the width of the convex portion 55A6a, in a manner to be connected to the rear side of the groove portion 50Ad.

### Harness 60A

The harness 60A is composed of the cables 62A and the second terminals 61A, as illustrated in FIGS. 4 and 12. The cable 62A is composed of a copper wire 62Aa made of copper alloys, and an insulating material 62Ab covering the copper wire 62Aa. The copper wire 62Aa is exposed in one end of the cable 62A, and the copper wire 62Aa in the exposed portion has a gradual change portion, whose cross section gradually changes from a circular shape to a rectangular shape, and a thin substantially-rectangular-parallelepiped portion (hereinafter also referred to as a "first rectangular-parallelepiped portion") extending from the gradual change portion to the tip end, in this example. The second terminal 61A has a thin copper plate which is a substantially-rectangular-parallelepiped portion (hereinafter also referred to as a "second rectangular-parallelepiped portion"). The first rectangular-parallelepiped portion and the second rectangular-parallelepiped portion are fixed by ultrasonic welding in this example. In the present embodiment, the above-mentioned gradual change portion, first rectangular-parallelepiped portion, and second rectangular-parallelepiped portion are collectively referred to as the second terminal 61A. In particular, the second rectangular-parallelepiped portion is also referred to as the second contact portion 61Aa. The second contact portion 61Aa in this example is configured to become one step narrower in width from the middle of the extension direction toward the tip end. The second rectangular-parallelepiped portion can be formed from the copper wire 62Aa instead of a separate member. In this configuration, the second contact portion 61Aa is solidified by compaction processing. That is, each of the pair of second terminals 61A is composed of a plurality of core wires (copper wires), and each of the second contact portions 61Aa is solidified by performing compaction processing to the core wires to form a substantially rectangular parallelepiped shape. The compaction processing facilitates miniaturization of the plug harness 3A. The second contact portion 61Aa has a surface 61Aa1 and a surface 61Aa2 opposite to the surface 61Aa1, which constitute a thickness h which is the plate thickness, as illustrated in FIG. 7. The second contact portion 61Aa has a flat plate shape which can be inserted into the second hole portion 50Aa in this example.

### Second holding member 70A

The second holding member 70A is a metal plate made of a thin rectangular flat plate with four rounded corners, as illustrated in FIG. 4. When the connection body 1A including the slide cover 55A is assembled, at least a portion of the second holding member 70A is exposed from the plug harness 3A. The second holding member 70A is made of stainless steel in this example. The second holding member 70A has a second pressing portion 70Aa and a third bolt insertion portion 70Ab. The second pressing portion 70Aa has a thin rectangular shape and is used for pressing a predetermined region (the surface 50Ad1) of the upper surface 50Ae, which is an outer surface of the second housing 50A and in which the second bolt insertion portion 50Ab is formed, in one direction (the -z direction in FIG. 4). The third bolt insertion portion 70Ab is formed on the center portion of the second pressing portion 70Aa so that the bolt 80A can be inserted therethrough. The third bolt insertion portion 70Ab is provided on a position facing the second bolt insertion portion 50Ab with the seal member 114A interposed therebetween in this example when the second holding member 70A is mounted on the surface 50Ad1. The second holding member 70A and the predetermined region (the surface 50Ad1) come into contact by a surface-to-surface contact. Therefore, even if the second housing 50A is made of resin, for example, depression (denting) of the contact part is prevented. In the connection body 1A of this example, the bolt 80A is inserted through the second holding member 70A via the spherical washer 118A.

The connection body 1A includes the seal member 114A which forms an O ring as a waterproof member in this example. For example, when busbars are screwed together, an over-housing for waterproofing is separately required for waterproof structure. In the connection body 1A, the seal member 114A serving as a waterproof member is attached to the second bolt insertion portion 50Ab from the upper surface 50Ae side, and then the second pressing portion 70Aa of the second holding member 70A is mounted on the surface 50Ad1. That is, the seal member 114A is provided on the second holding member 70A side on the second bolt insertion portion 50Ab. Accordingly, the connection body 1A does not require an over-housing.

### Slide cover 55A

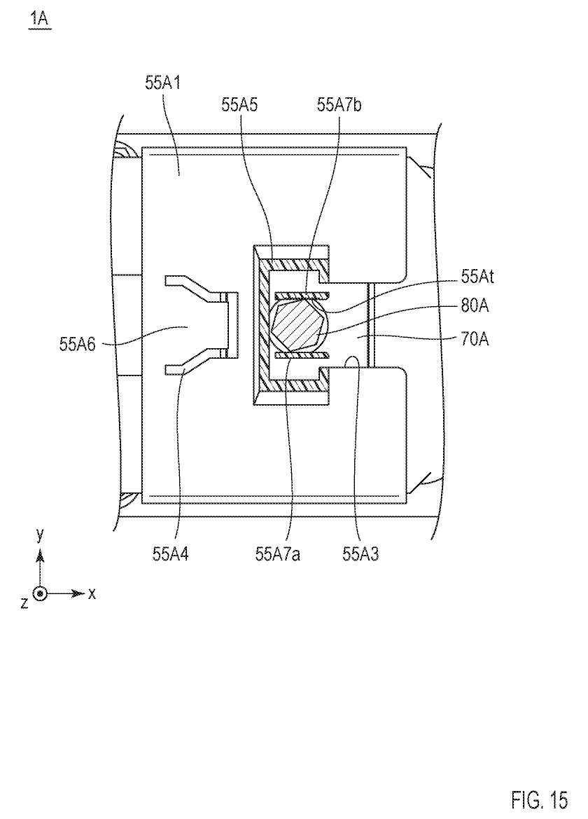

FIG. 14 is a perspective view illustrating the slide cover 55A. FIG. 15 is an enlarged view of the slide cover 55A and its surroundings in a sectional view taken along an S-S line in C of FIG. 3. The slide cover 55A is configured to be movable between a first position, at which the slide cover 55A does not cover the head portion of the bolt 80A, and a second position, at which the slide cover 55A covers the head portion of the bolt 80A but does not cover a portion of the second holding member 70A when the bolt 80A and the nut 40A are fastened, as described later. As illustrated in FIG. 7, the slide cover 55A is a resin cover whose cross section has a substantially-U shape and which covers the upper surface 50Ae of the second housing 50A. The slide cover 55A includes a cover main body 55A1, slide portions 55A2, and a bolt cover portion 55A5, as illustrated in FIG. 14. The cover main body 55A1 covers the upper surface 50Ae of the second housing 50A. The slide portions 55A2 protrude downward (the -z direction) from both respective end portions in the width direction (the y-axis direction) of the cover main body 55A1. The bolt cover portion 55A5 is provided on the center portion of the cover main body 55A1 and protrudes upward (the +z direction) from the cover main body 55A1 to cover the bolt head portion of the bolt 80A.

The cover main body 55A1 has a hole portion 55A4 formed in the rear side (the -x direction side) at the center portion in the width direction so as to have a lock claw portion 55A6 whose rear side is a fixed end and front side (the +x direction side) is a free end, as illustrated in FIG. 15. The lock claw portion 55A6 extends from the fixed end side to the free end side, with the fixed end side extending at a constant width to the center portion, the center portion gradually narrowing in width, and the free end side extending at a constant width. The free end of the lock claw portion 55A6 has the convex portion 55A6a (FIG. 12) protruding downward (the -z direction side) so as to engage with the first concave portion 50Ah and the second concave portion 50Ai which are provided in the upper surface 50Ae of the second housing 50A. The cover main body 55A1 has an opening portion 55A3 on the front side (the +x direction side) of the center portion so that the slide cover 55A does not collide with the bolt 80A even when the slide cover 55A moves from the first position to the second position.

The bolt cover portion 55A5 has a substantially trapezoidal cross section and is basically shaped as a rectangular prism extending from the rear side to the front side. The bolt cover portion 55A5 has opening portions on the front side and the bottom side, and is thus formed in the shape of a hollow rectangular prism which is open on the front side and the bottom side. Inside the bolt cover portion 55A5, a pair of rib-shaped guide portions 55A7a and 55A7b are provided from the front side to the rear side, as illustrated in FIGS. 7 and 15. The guide portions 55A7a and 55A7b are separated by a width which allows contact with the bolt head portion of the bolt 80A. In the present disclosure, the guide portions 55A7a and 55A7b are also collectively referred to as the "guide portions 55A7". The guide portion 55A7b has a plurality of grooves 55At formed on the inner side (the bolt 80A side) in the vertical direction (the z-axis direction). The grooves 55At come into contact with the head portion of the bolt 80A when the slide cover 55A moves from the first position to the second position, which will be described later, and create clockwise rotation in the view in FIG. 15, which is the direction in which the bolt 80A and the nut 40A are fastened, whereby no force is generated in the direction to loosen the bolt 80A. Furthermore, even if vibration or the like generated acts in a direction loosening the fastening of the bolt 80A, the grooves 55At at the second position can prevent this loosening. The fastening of the bolt 80A and the nut 40A can be thus made more reliable.

The slide portions 55A2 protrude downward (the -z direction) from both respective end portions in the width direction (the y-axis direction) of the cover main body 55A1. The pair of slide portions 55A2 each has the engagement portion 55A2a, which slightly protrudes in a direction toward the other slide portion 55A2 (the y-axis direction) from the tip end on the protruding side. The engagement portions 55A2a engage with the respective guide portions 50Ag of the second housing 50A, allowing the slide cover 55A to move along the guide portions 50Ag.

### Method for connecting connection body 1A

The method for connecting the connection body 1A can be performed, for example, by assembling the connection body 1A in accordance with processes (1) to (11) below. However, the processes in the method for connecting the connection body 1A are not limited to the processes described below. Further, in the description below, the process of attaching the bolts 85A and the collars 113A is omitted. In the present disclosure, steps (1) to (10) may also be referred to as the method for connecting the connection body 1A.

(1) For waterproofing, the first seal member 111A, which is an annular-shaped waterproof member, is attached to the groove portion, which is formed near the joint between the flange portion 10Ad and the base 10Ac, from the bottom surface side of the first housing 10A, as illustrated in FIG. 9. The second seal member 112A, which is an annular-shaped waterproof member, is attached to the groove portion, which is formed around the base 10Ac, from the boss 10Ag side of the first housing 10A.

(2) In order to mount one end of the elastic member 100A on the nut insertion portion 30Ab of the first holding member 30A, the other end of the elastic member 100A is inserted into the fourth bolt insertion portion 90Ab of the shutter member 90A.

(3) The first pressing portions 30Aa of the first holding member 30A are inserted into the respective hole portions 20Ae of the first terminals 20A. Further, the first contact portions 20Aa of the first terminals 20A are inserted into the respective shutter portions 90Aa.

(4) In the state of (3), the shutter portions 90Aa are inserted into the respective first hole portions 10Aa, and the fourth bolt insertion portion 90Ab is inserted into the boss 10Ag. In terms of the insertion depth, the insertion is continued until the convex portions 10Aj and the respective convex portions 20Ad are engaged with each other. Through the engagement between the convex portions 10Aj and the convex portions 20Ad, the pair of first terminals 20A, the shutter member 90A, the elastic member 100A, and the first holding member 30A are held in the first housing 10A. At this time, the ribs 90Ad are inserted through the hole portions 10Ai, whereby the shutter member 90A is movable upward with respect to the first housing 10A. The reaction force of the elastic member 100A produces the state in which the pair of shutter portions 90Aa cover the peripheries of respective one end portions of the pair of first contact portions 20Aa with the end portions exposed, as illustrated in FIG. 9.

(5) The nut portion 40Ab is inserted into the nut insertion portion 30Ab from below the first holding member 30A. This insertion is continued up to the position where the lock arm portions 40Aa2 engage with the convex portions 10Ak (see FIG. 5). The flange main body portion 40Aa1 is a thin metal flat plate having a substantially octagonal shape and having the size enough to cover the connecting portion 30Ac. The flange main body portion 40Aa1 covers the connecting portion 30Ac in a state in which the lower surface 40Aa6 is exposed. The nut portion 40Ab has the function of a spacer nut, and extends in a direction (the +z direction) opposite to the insertion direction of the bolt 80A as illustrated in FIG. 9. The longer the spacer nut function of the nut portion 40Ab, the longer the fastening portion with the bolt 80A can be secured, and accordingly the length of the bolt 80A can be reduced. This realizes the configuration in which the tip end of the bolt 80A does not reach the lowermost surface of the second housing 50A (the surface on the -z direction side on which the opening portion 50Ac is formed) when the bolt 80A is inserted into the second housing 50A (see FIG. 5). Thus, the employment of the above-mentioned configuration of the nut 40A makes it possible to reduce a risk of damage to the first housing 10A caused by a contact of the bolt 80A with the first housing 10A or a risk of the bolt 80A protruding further downward from the first housing 10A.

(6) The pair of second terminals 61A are inserted into the respective second hole portions 50Aa in a state in which the seal members 115A, the cable retainers 116A, and the covers 117A are attached to the harness 60A (see FIG. 6). Then, the seal members 115A, the cable retainers 116A, and the covers 117A are fitted to the first housing 10A in this order.

(7) The first housing 10A and the second housing 50A are fitted to each other in a manner in which each of the first hole portions 10Aa and the opening portion 50Ac face each other (FIGS. 4 and 6).

(8) The seal member 114A, which forms an O ring as a waterproof member in this example, is attached to the second bolt insertion portion 50Ab from the upper surface 50Ae side, and the second pressing portion 70Aa of the second holding member 70A is mounted on the surface 50Ad1.

(9) The slide cover 55A is attached to the second housing 50A by allowing its rear side (the -x direction side) of the slide cover 55A to face the front side of the second housing 50A and engaging the engagement portions 55A2a with the guide portions 50Ag of the second housing 50A. The slide cover 55A is moved along the guide portions 50Ag to a position where the convex portion 55A6a of the slide cover 55A engages with the first concave portion 50Ah (this position is also referred to as the "first position"). As a result, the slide cover 55A is restricted from moving in the +x direction with respect to the second housing 50A unless a force equal to or greater than a predetermined value is applied thereto. The opening portion 55A3 is formed so that when the slide cover 55A is positioned on the first position, the positional relationship between the slide cover 55A and the second housing 50A is such that the upper side of the second bolt insertion portion 50Ab is not covered and the bolt 80A can be inserted from above. That is, the first position is a position where the slide cover 55A does not cover the head portion of the bolt 80A in the connection body 1A.

(10) The spherical washer 118A is mounted from above the third bolt insertion portion 70Ab in a manner to face the second holding member 70A. The bolt 80A is inserted through the spherical washer 118A, the third bolt insertion portion 70Ab, the seal member 114A, the second bolt insertion portion 50Ab, the first bolt insertion portion 10Ab, the fourth bolt insertion portion 90Ab, the elastic member 100A, the nut insertion portion 30Ab, and the nut portion 40Ab in this order, and the bolt 80A and the nut 40A are fastened, thereby fastening the header 2A and the plug harness 3A. The connection body 1A uses the spherical washer 118A. Therefore, even if the first contact surfaces 20Ac cannot be positioned flush with each other in an assembly situation, for example because one of the pair of first contact surfaces 20Ac is positioned lower than the other first contact surface 20Ac due to a manufacturing error or the like, the connection body 1A can absorb the misalignment and ensure a mutually-equal pressing force on the pair of first contact surfaces 20Ac.

(11) After fastening the bolt 80A and the nut 40A, the slide cover 55A is moved along the guide portions 50Ag to a position where the convex portion 55A6a engages with the second concave portion 50Ai (this position is also referred to as the "second position"). When the slide cover 55A is positioned on the second position, the positional relationship between the slide cover 55A and the second housing 50A is as described below. Namely, the bolt cover portion 55A5 covers the top of the head portion of the bolt 80A and the guide portions 55A7a and 55A7b cover both sides of the head portion of the bolt 80A. This makes it impossible to insert a tool such as a spanner wrench for releasing the fastening between the bolt 80A and the nut 40A. In other words, the release of the fastening between the bolt 80A and the nut 40A is restricted. At this time, at least a portion of the second holding member 70A is exposed from the plug harness 3A. That is, the second position is a position where the head portion of the bolt 80A is covered but a portion of the second holding member 70A is not covered. The method for connecting the connection body 1A is thus completed. Here, if the bolt 80A is not tightened by a specified amount, the bolt cover portion 55A5 interferes with the head portion of the bolt 80A, thereby detecting that the bolt 80A is not tightened by the specified amount.

The above-mentioned fastening between the plug harness 3A and the header 2A moves the end portions of the first contact portions 20Aa from the position where the end portions are within the opening portions formed by the shutter member 90A (FIGS. 8 and 9) to the position where the end portions are flush with the end portion of the tip of the shutter member 90A (FIG. 7). In other words, the elastic member 100A causes the shutter member 90A to move from a position where the end portion (the first contact surface 20Ac) of the first contact portion 20Aa is within the opening portion formed by the shutter member 90A (FIGS. 8 and 9) to a position where the end portion of the first contact portion 20Aa and the end portion of the tip of the shutter member 90A are flush with each other (FIG. 7) from before the completion of fastening of the header 2A with the plug harness 3A by the bolt 80A and the nut 40A to the completion. To put it further, before fastening is completed, the shutter member 90A is pressed by the elastic member 100A, and the end portion of the shutter portion 90Aa is accordingly positioned on the pressing direction side of the first pressing portion 30Aa (the +z direction side in FIG. 8) relative to the end portion (the first contact surface 20Ac) of the first contact portion 20Aa. From before the completion of fastening to the completion, the shutter member 90A moves to a position where the end portion (the first contact surface 20Ac) of the first contact portion 20Aa is allowed to be conduct with the second contact portion 61Aa (the -z direction side in FIG. 8). Accordingly, the first contact surface 20Ac is joined with the second contact portion 61Aa.

The connection body 1A is configured so that the nut insertion portion 30Ab, through which the nut portion 40Ab is inserted, faces the fourth bolt insertion portion 90Ab, the fourth bolt insertion portion 90Ab faces the first bolt insertion portion 10Ab, the first bolt insertion portion 10Ab faces the second bolt insertion portion 50Ab, and the second bolt insertion portion 50Ab faces the third bolt insertion portion 70Ab with the seal member 114A interposed therebetween. Namely, the relative positional relationship between the third bolt insertion portion 70Ab, the second bolt insertion portion 50Ab, the first bolt insertion portion 10Ab, the fourth bolt insertion portion 90Ab, and the nut portion 40Ab is a positional relationship which allows the insertion of the bolt 80A to fasten the bolt 80A and the nut 40A. In the connection body 1A of the present disclosure, the fastening by the bolt 80A makes the first contact portions 20Aa and the respective second contact portions 61Aa conductive.

The relative positional relationship focusing on the nut portion 40Ab, the first bolt insertion portion 10Ab, the second bolt insertion portion 50Ab, and the third bolt insertion portion 70Ab is, in other words, as follows. That is, the first terminals 20A are inserted into the respective first hole portions 10Aa from the first contact surface 20Ac (this state is also referred to as the "first state"). In the first state, the pair of first pressing portions 30Aa are allowed to press the respective first terminals 20A. The pair of second terminals 61A are inserted into the respective second hole portions 50Aa provided in pair. The first housing 10A and the second housing 50A are fitted to each other in a manner in which each of the first hole portions 10Aa and the opening portion 50Ac face each other. The second pressing portion 70Aa of the second holding member 70A is mounted on the predetermined region (the surface 50Ad1). The first pressing portions 30Aa of the first holding member 30A are allowed to be abutted on the respective surfaces opposite to the first contact surfaces 20Ac of the first terminals 20A (the state up to this point is also referred to as the "second state"). In the second state, the relative positional relationship between the nut portion 40Ab, the first bolt insertion portion 10Ab, the second bolt insertion portion 50Ab, and the third bolt insertion portion 70Ab is the positional relationship that allows the insertion of a single bolt (the bolt 80A) to fasten the bolt 80A and the nut 40A. The fastening between the bolt 80A and the nut 40A makes the first contact portions 20Aa and the respective second contact portions 61Aa conductive.

The connection body 1A of the present embodiment is configured so that the header 2A and the plug harness 3A are fitted to each other and fastening by the fitting can be performed with a single bolt 80A and the nut 40A. The connection body 1A is configured to directly join the first terminals 20A to the second terminals 61A. The direct joining can be performed by a single bolt 80A and the nut 40A. Accordingly, this configuration does not require, for example, a separate metal fitting such as the second terminal metal fitting body 86 of Patent Literature 1, which is joined to terminals to join terminals. Further, the connection body 1A is configured so that the first terminals 20A and the second terminals 61A are directly joined to each other to be conductive. Patent Literature 1 employs the configuration joining by the clip spring 88 serving as an elastic member. The joining by springs requires plating to reduce contact resistance. The connection body 1A can achieve conduction between terminals by direct joining between the first terminals 20A and the second terminals 61A. Further, the connection body 1A can obtain high contact force by bolt fastening force and can accordingly significantly reduce the electrical resistance, eliminating necessity of plating. As a result, the connection body 1A of the present disclosure can suppress increase in the number of components and can achieve connection that can withstand large currents.

In the present embodiment, the harness 60A is mounted so that the surfaces 61Aa1 are abutted on the end portions (the first contact surfaces 20Ac) on the upper side (the +z direction side in FIG. 7) of the first contact portions 20Aa. The present embodiment is not limited to this configuration.

For example, the harness 60A may be configured so that the harness 60A is rotated by 90 degrees around the longitudinal direction (the x-axis direction in FIG. 7) of the harness 60A as an axis, and surfaces 61Aa3 or surfaces 61Aa4 (see FIG. 7) are abutted on the end portions (the first contact surfaces 20Ac) on the upper side of the first contact portions 20Aa. Alternatively, the first terminals 20A may be configured so that the first terminals 20A are rotated by 90 degrees around the longitudinal direction (the x-axis direction in FIG. 4) of the harness 60A as an axis and the surfaces 61Aa1 (see FIG. 7) are abutted on surfaces 20Aa1 (or surfaces 20Aa2), forming a flat plate shape, of the first contact portions 20Aa. In these configurations, the shapes of other components, including the first housing 10A, the second housing 50A, and the like, are to be changed as appropriate in accordance with the arrangement positions of the shapes.

Thus, in the connection body 1A of the present embodiment, the pair of first contact portions 20Aa and the pair of second contact portions 61Aa may be provided so that at least one of the pair of first contact portions 20Aa and the pair of second contact portions 61Aa are raised "along" the insertion direction of the bolt 80A or may be provided so that at least one of the pair of first contact portions 20Aa and the pair of second contact portions 61Aa are raised "with respect to" the insertion direction of the bolt 80A, as long as the first contact portions 20Aa and the second contact portions 61Aa can be directly joined to each other.

In the connection body 1A of the present disclosure, at least a portion of the second holding member 70A, which is made of metal, is exposed from the plug harness 3A when the connection body 1A is assembled. Therefore, the connection body 1A of the present disclosure can dissipate heat from the second holding member 70A, which has a higher thermal conductivity than the material of the second housing 50A, even when the connection body 1A generates heat due to electric currents.

In the connection body 1A of the present disclosure, when the connection body 1A is assembled, the flange portion 40Aa made of metal is exposed from the header 2A at least at a portion of the lower surface 40Aa6 which is opposite to the surface (the upper surface 40Aa5) which presses the connecting portion 30Ac. Therefore, the connection body 1A of the present disclosure can dissipate heat from the flange portion 40Aa, which has a higher thermal conductivity than the material of the first housing 10A, even when the connection body 1A generates heat due to electric currents. Further, the flange main body portion 40Aa1 is a thin metal flat plate having the substantially octagonal shape and having the size enough to cover the connecting portion 30Ac. Therefore, when a component or product using the connection body 1A has a cooling function, the heat generated in the connection body 1A can be introduced to the cooling function. For example, the flange main body portion 40Aa1 of the flange portion 40Aa is connected to a portion of other components or products. Thus, the connection body 1A can be actively cooled by utilizing a cooling function of other components or products.

The embodiment of the present disclosure has been described above. Although the present disclosure mentions copper as an actual conductive member, stainless steel as a metal, and resin or glass epoxy resin as an insulator, not limited to the specific materials illustrated in the examples, the connection body of the present disclosure may use other materials within the scope of the conductive members, metal members, insulating members, and the like described in the present disclosure. In addition, it goes without saying that the above-described connection body can be modified as appropriate without departing from the spirit and scope of the present disclosure.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A connection body comprising:
a header; and
a plug harness which is fitted to the header, wherein
the header includes
a first housing which is made of an insulating material and has a pair of first hole portions formed in parallel with each other in a penetrating manner and a first bolt insertion portion formed between the pair of first hole portions in parallel with the pair of first hole portions,
a pair of first terminals which have first contact surfaces on one ends thereof and have first contact portions having flat plate shapes to be able to be inserted into the respective first hole portions from a first contact surface side,
a first holding member which is made of an insulating material and has a pair of first pressing portions for pressing each of the first terminals from a surface side opposite to the first contact surfaces to the first contact surface side in a first state in which the first terminals are inserted into the respective first hole portions from the first contact surfaces, a connecting portion for connecting the first pressing portions to each other, and a nut insertion portion formed in the connecting portion, and
a nut which has a nut portion and a flange portion, the nut portion having a first end portion inserted into the nut insertion portion from a side opposite to a side on which the first pressing portions press and a second end portion opposite to the first end portion, the flange portion being made of metal and being fixed to the second end portion and engaging with a predetermined portion of the first housing so as to press the connecting portion from the side opposite to the side on which the first pressing portions press, and
the plug harness includes
a second housing which is made of an insulating material, can be fitted to the first housing, and has a pair of second hole portions formed in parallel with each other so that at least portions thereof face the first contact surfaces when the plug harness is fitted to the header, an opening portion formed so as to encompass a portion of each of the second hole portions and open in one direction of a first axis, the first axis intersecting with a hole direction of the second hole portions, and a second bolt insertion portion formed between the pair of second hole portions in parallel with the first axis,
a pair of second terminals which have second contact portions on one ends thereof, the second contact portions having flat plate shapes to be able to be inserted into the respective second hole portions, and
a second holding member which is made of metal and has a second pressing portion used for pressing a predetermined region of a first surface in the one direction, the first surface being an outer surface of the second housing and having the second bolt insertion portion formed therein, and a third bolt insertion portion penetrating through the second pressing portion, and
a positional relationship between the nut portion, the first bolt insertion portion, the second bolt insertion portion, and the third bolt insertion portion is a positional relationship which allows fastening of the bolt and the nut by insertion of a single bolt in a second state in which the pair of first pressing portions are allowed to press the respective first terminals, the pair of second terminals are inserted into the respective second hole portions provided in pair, the first housing and the second housing are fitted to each other in a manner in which each of the first hole portions and the opening portion face each other, the second pressing portion of the second holding member is mounted on the predetermined region, and the first pressing portions of the first holding member are allowed to be abutted on respective surfaces, the surfaces being on an opposite side to the first contact surfaces of the first terminals, in the first state, and the fastening makes the first contact portions and the respective second contact portions conductive.

2. The connection body according to claim 1, wherein the flange portion is exposed from the header at least at a portion of a surface which is opposite to a surface pressing the connecting portion.

3. The connection body according to claim 1, wherein at least a portion of the second holding member is exposed from the plug harness.

4. The connection body according to claim 1, wherein the flange portion has a lock arm portion and engagement with the predetermined portion of the first housing is performed such that the lock arm portion engages with the predetermined portion of the first housing.

5. The connection body according to claim 4, wherein the nut portion is a spacer nut.

6. The connection body according to claim 1, wherein the bolt is inserted through the second holding member via a spherical washer.

7. The connection body according to claim 1, wherein
the plug harness further includes a slide cover, and
the slide cover is movable between a first position, at which the slide cover does not cover a head portion of the bolt, and a second position, at which the slide cover covers the head portion of the bolt but does not cover a portion of the second holding member when the bolt and the nut are fastened.
